(19) United States
(12) Patent Application Publication
(10) Pub. No.: US 2026/0370102 A1
(43) Pub. Date: Nov. 19, 2026

(54) LAMINATED BODY MANUFACTURING APPARATUS AND LAMINATED BODY MANUFACTURING METHOD

(71) Applicant: NHK SPRING CO., LTD., Yokohama-shi, Kanagawa (JP)

(72) Inventor: Michinobu HIRAMA, Yokohama-shi, Kanagawa (JP)

(21) Appl. No.: 19/148,238

(22) PCT Filed: Jan. 15, 2024
(86) PCT No.: PCT/JP2024/000772

§ 371 Date: Jul. 15, 2025

(30) Foreign Application Priority Data
Jan. 17, 2023 (JP) 2023-005468

(51) Int. Cl. H02K 15/0273; H02K 15/027

(52) U.S. Cl. CPC H02K 15/0273; H02K 15/027

(57) ABSTRACT

A method of manufacturing a laminated body in which latching iron core members and non-latching iron core members are selectively punched from a metal sheet and laminated, the method including: using a first die that forms non-latching iron core member contour shapes to punch a plurality of latching piece forming regions of the metal sheet when forming the non-latching iron core members; using a second die for forming latching iron core member contour shapes to punch the latching piece forming regions of the metal sheet when forming the latching iron core members and the non-latching iron core members; using a third die to punch the metal sheet in order to separate the latching iron core members and the non-latching iron core members from the metal sheet; and controlling the timing of the supply of the latching iron core members and the non-latching iron core members to a receiving member.

### TECHNICAL FIELD

This disclosure relates to a laminated body manufacturing apparatus and a laminated body manufacturing method.

### BACKGROUND ART

Laminated bodies in which a plurality of iron core members are laminated have conventionally been manufactured to obtain motor cores (rotor cores or stator cores) that are used in motors installed in electric vehicles.

JP-A No. 2019-118169 describes using a plate laminating apparatus to manufacture a laminated body configuring a stator core. In this plate laminating apparatus, a sensor that detects the passage of plates conveyed out from a cylinder serving as a conveyance path and a separation mechanism that supports the plates are provided near the cylinder outlet. Additionally, based on the detection results of the sensor, the separation mechanism is projected onto the plate conveyance path at an optional timing to stop the conveyance of the plates, thereby controlling the supply number and the supply timing of the plates supplied to a jig.

### SUMMARY OF INVENTION

### Technical Problem

If the timing of the projection of the separation mechanism is decided based only on the detection results of the sensor that detects the passage of the plates conveyed out from the cylinder as in the plate laminating apparatus of JP-A No. 2019-118169, the amount of time from when the passage of the plates is detected until the operation of the separation mechanism is completed becomes extremely short when the speed at which the plates are conveyed out from the cylinder is relatively fast. Consequently, the actuator and sensor of the separation mechanism as well as the device for controlling these need to have a fast response speed, and the difficulty of controlling them also increases. Furthermore, if the operating speed of the separation mechanism is reduced by, for example, deterioration of the actuator of the separation mechanism over time, the problem can arise that plates that should stop being conveyed arrive before the operation of the separation mechanism is completed, and the conveyance of those plates cannot be stopped. Moreover, in order to precisely operate the separation mechanism, the need arises to frequently check for deterioration of the actuator of the separation mechanism over time, which increases the frequency of maintenance.

The present disclosure provides a laminated body manufacturing apparatus and a laminated body manufacturing method that are capable of accurately and efficiently carrying out laminating of iron core members without requiring special devices or the like.

### Solution to Problem

A laminated body manufacturing method pertaining to a first aspect of the disclosure is a method of manufacturing a laminated body in which a plurality of iron core members including latching iron core members that have latching pieces in a plurality of places on their outer peripheral surfaces and non-latching iron core members that do not have the latching pieces are selectively punched from a metal sheet conveyed along a first conveyance direction and in which the plurality of iron core members that have been punched are laminated, the method comprising: a step of using a first die, which is capable of forming non-latching iron core member contour shapes that are formed in outer peripheral surfaces of the non-latching iron core members, to punch a plurality of latching piece forming regions of the metal sheet where the latching pieces are to be formed when forming the non-latching iron core members; a step of using a second die, which is capable of forming latching iron core member contour shapes including the latching pieces that are formed in the outer peripheral surfaces of the latching iron core members, to punch the latching piece forming regions of the metal sheet when forming the latching iron core members and the non-latching iron core members, the latching iron core member contour shapes including parts that are positioned on outer sides of the non-latching iron core member contour shapes in plan view when the latching iron core members and the non-latching iron core members are laminated; a step of using a third die to punch the metal sheet in order to separate the latching iron core members and the non-latching iron core members from the metal sheet; and a step of controlling the timing of the supply of the latching iron core members and the non-latching iron core members to a receiving member by supporting the latching pieces of the latching iron core members that have been separated from the metal sheet.

In the above laminated body manufacturing method, two iron core members having different shapes can be selectively punched, and the supply timing of the iron core members can be controlled by supporting the latching pieces of the latching iron core members. Because of this, the supply timing of the iron core members can be adjusted without using special devices or the like, and the laminating of the iron core members can be efficiently implemented without for example stopping the apparatus. Furthermore, two iron core members can be continuously manufactured by simply controlling the necessity of the punching process using the first die, so that complicated control is unnecessary when selectively punching the two iron core members.

A laminated body manufacturing method pertaining to a second aspect of the disclosure is the laminated body manufacturing method pertaining to the first aspect of the disclosure, wherein along the first conveyance direction first to third punching regions are sequentially provided from upstream in the first conveyance direction, and the step of using the first die to punch the metal sheet is implemented in the first punching region, the step of using the second die to punch the metal sheet is implemented in the second punching region, and the step of using the third die to punch the metal sheet is implemented in the third punching region.

In the above laminated body manufacturing method, by disposing the dies for forming the contour shapes of the latching piece forming regions of the iron core members in places different from that of the die for performing outer diameter punching, the punching of the contour shapes of the latching piece forming regions can be precisely implemented.

A laminated body manufacturing method pertaining to a third aspect of the disclosure is the laminated body manufacturing method pertaining to the first aspect of the disclosure, wherein along the first conveyance direction first and fourth punching regions are sequentially provided from upstream in the first conveyance direction, and the step of using the first die to punch the metal sheet is implemented in the first punching region, and the step of using the second die to punch the metal sheet and the step of using the third die to punch the metal sheet are implemented in the fourth punching region by a fourth die configured by the second die and the third die.

In the above laminated body manufacturing method, the step of punching with the second die and the step of punching with the third die can be implemented at one time by using the fourth die, so the number of man-hours required for punching can be reduced.

A laminated body manufacturing method pertaining to a fourth aspect of the disclosure is the laminated body manufacturing method pertaining to any of the first to third aspects of the disclosure, wherein the step of controlling the timing of the supply of the latching iron core members and the non-latching iron core members to the receiving member includes a step of supplying the latching iron core members and the non-latching iron core members that have been separated from the metal sheet to a squeeze and a step of supplying the iron core members to the receiving member from an end portion of the squeeze located downstream in a second conveyance direction intersecting the first conveyance direction, and the squeeze includes a squeeze upstream portion that is positioned on the second conveyance direction upstream side of the squeeze and laterally supports a plurality of the latching iron core members and the non-latching iron core members passing through the squeeze and a squeeze downstream portion that is positioned on the second conveyance direction downstream side of the squeeze and laterally supports the latching pieces of the latching iron core members passing through the squeeze.

In the above laminated body manufacturing method, the timing of the supply of the iron core members to the receiving member can be simply adjusted by passing the iron core members through the squeeze, so laminated bodies can be continuously manufacturing without stopping the apparatus, thus improving production efficiency.

A laminated body manufacturing apparatus pertaining to a fifth aspect of the disclosure comprises: a conveyance mechanism that conveys, along a first conveyance direction, a metal sheet from which a plurality of iron core members including latching iron core members that have latching pieces in a plurality of places on their outer peripheral surfaces and non-latching iron core members that do not have the latching pieces are capable of being selectively punched; a first die capable of forming, in a plurality of latching piece forming regions of the metal sheet where the latching pieces are to be formed, non-latching iron core member contour shapes that are formed in the outer peripheral surfaces of the non-latching iron core members; a second die capable of forming, in the latching piece forming regions of the metal sheet, latching iron core member contour shapes including the latching pieces that are formed in the outer peripheral surfaces of the latching iron core members, the latching iron core member contour shapes including parts that are positioned on outer sides of the non-latching iron core member contour shapes in plan view when the latching iron core members and the non-latching iron core members are laminated; a third die capable of separating the latching iron core members and the non-latching iron core members from the metal sheet; a press machine capable of operating the first die, the second die, and the third die; a receiving member that receives the latching iron core members and the non-latching iron core members that have been separated from the metal sheet; a support mechanism capable of supporting the latching pieces of the latching iron core members separated from the metal sheet; and a control device that controls implementation of a punching operation by the first die.

In the above laminated body manufacturing apparatus, two iron core members having different shapes can be selectively punched, and the supply timing of the iron core members can be controlled by supporting the latching pieces of the latching iron core members. Because of this, the supply timing of the iron core members can be adjusted without using special devices or the like, and the laminating of the iron core members can be efficiently implemented without for example stopping the apparatus. Furthermore, two iron core members can be manufactured by simply controlling the first die, so that complicated control is unnecessary.

A laminated body manufacturing apparatus pertaining to a sixth aspect of the disclosure is the laminated body manufacturing apparatus pertaining to the fifth aspect of the disclosure, wherein the support mechanism includes a squeeze capable of conveying, in a second conveyance direction intersecting the first conveyance direction, the latching iron core members and the non-latching iron core members that have been separated from the metal sheet, and the squeeze includes a squeeze upstream portion that is positioned on the second conveyance direction upstream side of the squeeze and laterally supports a plurality of the latching iron core members and the non-latching iron core members passing through the squeeze and a squeeze downstream portion that is positioned on the second conveyance direction downstream side of the squeeze and laterally supports the latching pieces of the latching iron core members passing through the squeeze.

In the above laminated body manufacturing apparatus, the timing of the supply of the iron core members to the receiving member can be simply adjusted by passing the iron core members through the squeeze, so laminated bodies can be continuously manufacturing without stopping the apparatus, thus improving production efficiency.

### Advantageous Effects of Invention

According to the laminated body manufacturing apparatus and the laminated body manufacturing method of this disclosure, it becomes possible to accurately and efficiently carry out laminating of iron core members without requiring special devices or the like.

### BRIEF DESCRIPTION OF DRAWINGS

FIG. 1A is a plan view showing an example of a latching iron core member punched in a laminated body manufacturing method pertaining to a first embodiment of the disclosure.

FIG. 1B is an enlarged view of part A of FIG. 1A.

FIG. 2A is a plan view showing an example of a non-latching iron core member punched in the laminated body manufacturing method pertaining to the first embodiment of the disclosure.

FIG. 2B is an enlarged view of part B of FIG. 2A.

FIG. 3 is a schematic explanatory drawing showing an example of a laminated body manufacturing apparatus pertaining to the first embodiment of the disclosure.

FIG. 4 is a sectional view taken along line D-D of FIG. 3.

FIG. 5 is a sectional view taken along line E-E of FIG. 3.

FIG. 6 is a flowchart showing an example of the laminated body manufacturing method pertaining to the first embodiment of the disclosure.

FIG. 7A is a schematic plan view of a metal sheet in each operating state shown in FIG. 6 and is an explanatory drawing showing the state of the metal sheet when punching the latching iron core member.

FIG. 7B is a schematic plan view of a metal sheet in each operating state shown in FIG. 6 and is an explanatory drawing showing the state of the metal sheet when punching the latching iron core member.

FIG. 7C is a schematic plan view of a metal sheet in each operating state shown in FIG. 6 and is an explanatory drawing showing the state of the metal sheet when punching the latching iron core member.

FIG. 7D is a schematic plan view of a metal sheet in each operating state shown in FIG. 6 and is an explanatory drawing showing the state of the metal sheet when punching the latching iron core member.

FIG. 8A is a schematic plan view of a metal sheet in each operating state shown in FIG. 6 and is an explanatory drawing showing the state of the metal sheet when punching the non-latching iron core member.

FIG. 8B is a schematic plan view of a metal sheet in each operating state shown in FIG. 6 and is an explanatory drawing showing the state of the metal sheet when punching the non-latching iron core member.

FIG. 8C is a schematic plan view of a metal sheet in each operating state shown in FIG. 6 and is an explanatory drawing showing the state of the metal sheet when punching the non-latching iron core member.

FIG. 8D is a schematic plan view of a metal sheet in each operating state shown in FIG. 6 and is an explanatory drawing showing the state of the metal sheet when punching the non-latching iron core member.

FIG. 9 is a flowchart showing an example of a process implemented after each process shown in FIG. 6.

FIG. 10A is an operational explanatory drawing showing main parts of the manufacturing apparatus shown in FIG. 3 when the laminated body manufacturing method shown in FIG. 9 is executed.

FIG. 10B is an operational explanatory drawing showing main parts of the manufacturing apparatus shown in FIG. 3 when the laminated body manufacturing method shown in FIG. 9 is executed.

FIG. 10C is an operational explanatory drawing showing main parts of the manufacturing apparatus shown in FIG. 3 when the laminated body manufacturing method shown in FIG. 9 is executed.

### DESCRIPTION OF EMBODIMENTS

This application is based on Japanese Patent Application No. 2023-005468 filed in Japan on Jan. 17, 2023, the contents of which form part of the contents of the present application.

Furthermore, the present disclosure will become more fully understood from the following detailed description. Further ranges of application of the present application will become apparent from the following detailed description. However, the detailed description and specific examples are preferred embodiments of the disclosure and are given only for the purpose of illustration. From this detailed description, a variety of changes and modifications will be apparent to those skilled in the art within the spirit and scope of the disclosure.

Applicant has no intention of dedicating any of the described embodiments to the public, and among the disclosed modifications and alternatives, those that might not literally fall within the scope of the claims are also to be regarded as part of the invention under the doctrine of equivalents.

Embodiments for implementing the disclosure will be described below with reference to the drawings. It will be noted that in the following, ranges that are necessary for description for achieving the object of the disclosure will be schematically described, ranges that are necessary for description of the relevant parts of the disclosure will be mainly described, and areas for which description is omitted will be based on publicly known technologies. Furthermore, identical or similar reference signs are assigned to mutually identical or corresponding members in the drawings, and redundant description will be omitted. Moreover, when a single drawing includes a plurality of mutually identical or corresponding members, reference signs may be assigned only to some of them in order to facilitate viewing of the drawing. Moreover still, unless otherwise noted in the specification, the constituent elements of the disclosure are not limited to one and may be present in plural numbers.

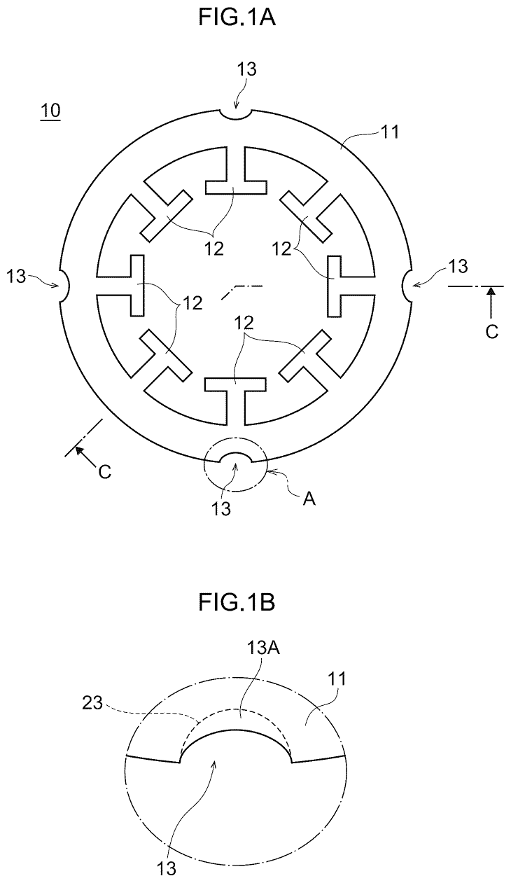

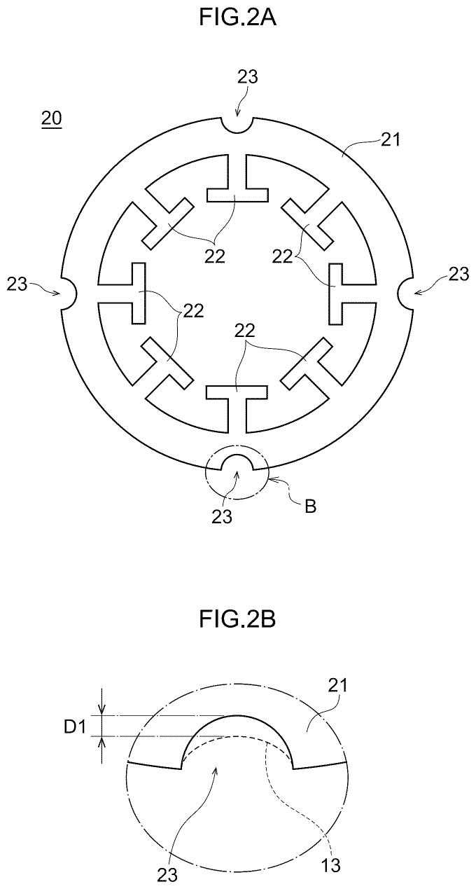

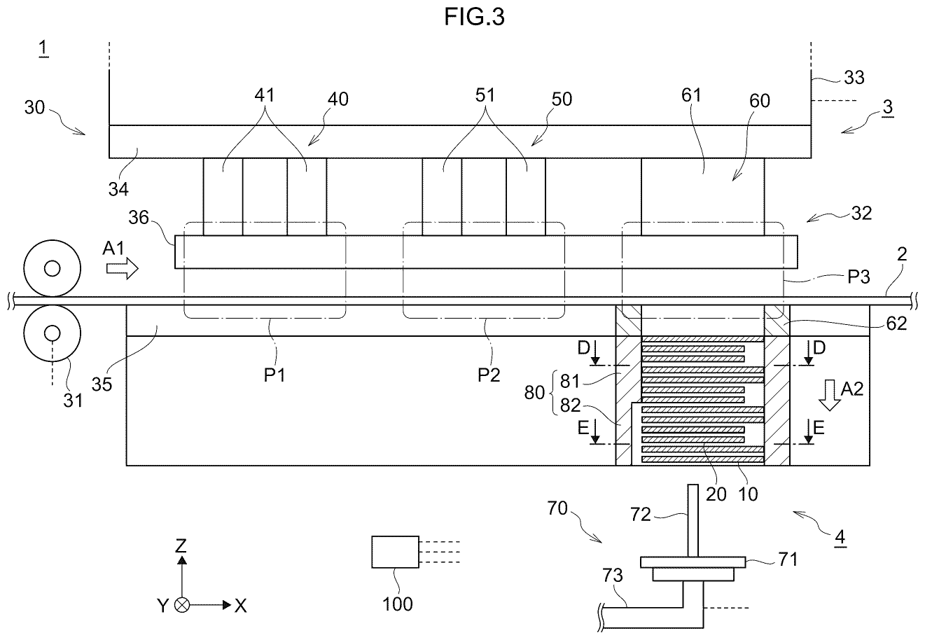

A laminated body manufacturing apparatus 1 (see FIG. 3) and a laminated body manufacturing method pertaining to a first embodiment described below form two types of iron core members, latching iron core members 10 that have latching pieces 13A (see FIG. 1) and non-latching iron core members 20 that do not have the latching pieces 13A (see FIG. 2), and laminate these to manufacture a laminated body. Thus, below, before describing details about the manufacturing apparatus 1 and the manufacturing method, the structures of the iron core members will be briefly described.

The iron core members that are laminated in the present embodiment may be capable of configuring a block core as a result of more than one being laminated, and the block core can, on its own or as a result of more than one being laminated, configure a motor core, such as a stator core of an inner rotor type rotating electric machine for example. It will be noted that “laminated body” in this disclosure refers to a plurality of iron core members that have simply been stacked, while a laminated body in which the iron core members have been joined together by welding or the like will be called a “motor core,” to distinguish between the two. Furthermore, the motor core may be either a divided stator core or a non-divided stator core and furthermore may configure a non-divided rotor core rather than a stator core

FIG. 1 are drawings showing an example of a latching iron core member supplied to a laminated body manufacturing apparatus pertaining to a first embodiment of the disclosure, with FIG. 1A being a plan view and FIG. 1B being an enlarged view of part A of FIG. 1A. As shown in FIG. 1A, a latching iron core member 10 configuring part of a plurality of iron core members pertaining to the present embodiment can be configured by a single plate-shaped electromagnetic steel sheet having a predetermined thickness (which is sometimes called a “core piece”). Specifically, the latching iron core member 10 can include a substantially annular yoke 11 having formed in its center portion a through hole in which a rotor core is capable of being disposed, teeth 12 that are substantially T-shaped in plan view and provided on the inner periphery of the yoke 11 so as to project toward the center portion of the yoke 11, and a plurality of latching iron core member recessed portions (an example of latching iron core member contour shapes) 13 that are formed in the outer peripheral surface of the yoke 11 and parts of which can function as latching pieces 13A.

The teeth 12 provided on the inner peripheral surface of the latching iron core member 10 may be provided in a plural number, such as eight for example, at substantially equal intervals along the inner peripheral surface. Armature coils can be wound around the teeth 12 when they are assembled into a stator core. It will be noted that the specific shape and arrangement of the teeth 12 can be changed as appropriate.

The latching iron core member recessed portions 13 provided in the outer peripheral surface of the latching iron core member 10 may be provided in a plural number, such as four for example, at substantially equal intervals along the outer periphery of the latching iron core member 10. In addition, the positions where the four latching iron core member recessed portions 13 are provided are, as shown in FIG. 1A, preferably on the radial direction outer side of any of the eight teeth 12 provided on the inner peripheral surface of the latching iron core member 10. Normally, the density of the magnetic flux generated when the latching iron core member 10 is operated as part of a motor core tends to be lower on the radial direction outer side of the teeth 12 compared with other positions. Consequently, by disposing the latching iron core member recessed portions 13 on the radial direction outer side of the teeth 12 as described above, deterioration of the magnetic characteristics of the motor core caused by providing the latching iron core member recessed portions 13 can be inhibited.

As shown in FIG. 1B, parts of the inner peripheral surfaces of the latching iron core member recessed portions 13 can function as latching pieces 13A. The latching pieces 13A function as regions supported in a later-described squeeze 80 after the latching iron core member 10 is punched. It will be noted that although FIG. 1 show an example where the latching iron core member recessed portions 13 are arc-shaped depressions and the bottom areas of those depressions function as the latching pieces 13A, the shape of the latching iron core member recessed portions 13 and the arrangement of the latching pieces 13A can be changed as appropriate within a range in which their functions can be maintained. Likewise, the numbers of the latching iron core member recessed portions 13 and the latching pieces 13A can also be changed as appropriate.

FIG. 2 are drawings showing an example of a non-latching iron core member supplied to the laminated body manufacturing apparatus pertaining to the first embodiment of the disclosure, with FIG. 2A being a plan view and FIG. 2B being an enlarged view of part B of FIG. 2A. As shown in FIG. 2A, a non-latching iron core member 20 configuring part of a plurality of iron core members pertaining to the present embodiment can be configured by a single plate-shaped electromagnetic steel sheet having a predetermined thickness. Specifically, the non-latching iron core member 20 can include a substantially annular yoke 21 having formed in its center portion a through hole in which a rotor core is capable of being disposed, teeth 22 that are substantially T-shaped in plan view and provided on the inner peripheral surface of the yoke 21 so as to project toward the center portion of the yoke 21, and a plurality of non-latching iron core member recessed portions (an example of non-latching iron core member contour shapes) 23 that are formed in the outer peripheral surface of the yoke 21. In other words, the non-latching iron core member 20 can be said to include the same configuration as the latching iron core member 10 except that it has the non-latching iron core member recessed portions 23 instead of the latching iron core member recessed portions 13. Consequently, the yoke 11 and teeth 12 of the latching iron core member 10 and the yoke 21 and teeth 22 of the non-latching iron core member 20 may have the same dimensions, arrangement, and number.

As shown in FIG. 2B, the non-latching iron core member recessed portions 23 provided in the outer peripheral surface of the non-latching iron core member 20 may be provided in a plural number, such as four for example, at substantially equal intervals along the outer periphery of the non-latching iron core member 20. In addition, the positions where the four non-latching iron core members 20 are provided are preferably the same positions as the latching iron core member recessed portions 13, that is, on the radial direction outer side of any of the eight teeth 22 provided on the inner peripheral surface of the non-latching iron core member 20.

Here, although the non-latching iron core member recessed portions 23 are formed in positions that coincide with the latching iron core member recessed portions 13 when the latching iron core member 10 and the non-latching iron core member 20 are combined into a laminated body, their depth in the radial direction is adjusted so as to be longer than that of the latching iron core member recessed portions 13. In other words, the latching iron core member recessed portions 13 include parts that are positioned on outer sides of the non-latching iron core member recessed portions 23 in plan view when the latching iron core member 10 and the non-latching iron core member 20 are laminated. Additionally, these parts positioned on the outer sides can function as the latching pieces 13A. More specifically, the latching iron core member recessed portions 13 have a shorter radial direction depth compared with the non-latching iron core member recessed portions 23 as indicated by the dotted line in FIG. 2B, and the regions of the latching iron core member 10 where this difference D1 is formed function as the latching pieces 13A as shown in FIG. 1B. It will be noted that the difference D1 may be a tiny difference and can, for example, be equal to or less than the thickness of the latching iron core member 10 and the non-latching iron core member 20.

Below, a manufacturing apparatus and a manufacturing method that manufacture a laminated body by punching the latching iron core member 10 and the non-latching iron core member 20 having the above configurations will be described.

### Laminated Body Manufacturing Apparatus

FIG. 3 is a schematic explanatory drawing showing an example of a laminated body manufacturing apparatus pertaining to the first embodiment of the disclosure. As shown in FIG. 3, a laminated body manufacturing apparatus 1 pertaining to the present embodiment may include a punching unit 3 that punches the latching iron core members 10 and the non-latching iron core members 20 from a metal sheet 2 and a laminating unit 4 that laminates the latching iron core members 10 and the non-latching iron core members 20 to form a laminated body. It will be noted that, in the following, description will be given taking the direction indicated by arrow X shown in FIG. 3 as a left and right direction, and similarly below, taking the direction indicated by arrow Y as a front and rear direction, and taking the direction indicated by arrow Z as an up and down direction.

As shown in FIG. 3 the punching unit 3 of the laminated body manufacturing apparatus 1 can be configured mainly by a progressive die mechanism 30. The progressive die mechanism 30 includes a conveyance mechanism 31 that conveys the metal sheet 2 along a first conveyance direction A1, a die unit 32 for punching the metal sheet 2 into predetermined shapes, and a press machine 33 capable of operating the die unit 32 in a direction intersecting the first conveyance direction A1.

The conveyance mechanism 31 is a mechanism for conveying the metal sheet 2 in the first conveyance direction A1 (e.g., the left and right direction). The metal sheet 2 conveyed by the conveyance mechanism 31 can be configured by a strip configured by an electromagnetic steel sheet that is long in one direction.

On the conveyance path of the metal sheet 2 conveyed by the conveyance mechanism 31, a plurality, such as three for example, of punching regions P1 to P3 may be sequentially provided at predetermined intervals. In these first to third punching regions P1 to P3, first to third dies 40, 50, 60 described below may be respectively disposed. In association with this, the conveyance of the metal sheet 2 by the conveyance mechanism 31 can be intermittently implemented at a conveyance pitch identical to the intervals between each of the punching regions.

The press machine 33 may be a device capable of operating the die unit 32 in the up and down direction. The press machine 33 operates the entire die unit 32 in the up and down direction. Consequently, when the die unit 32 moves up and down, all punches of the first to third dies 40, 50, 60 described below move up and down.

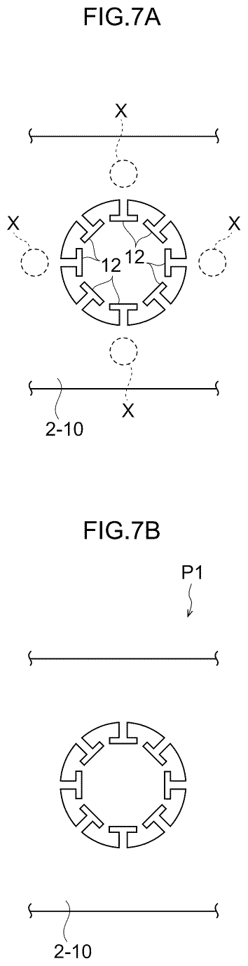

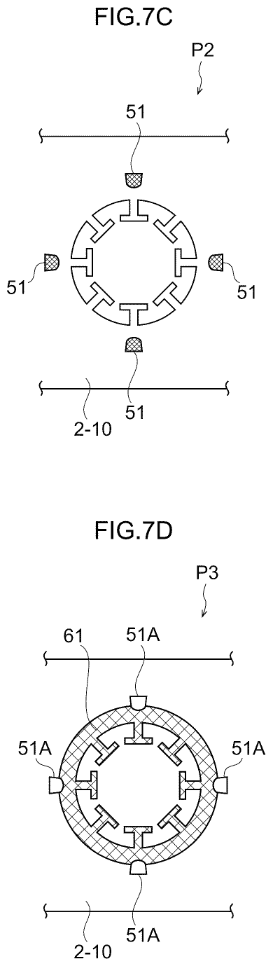

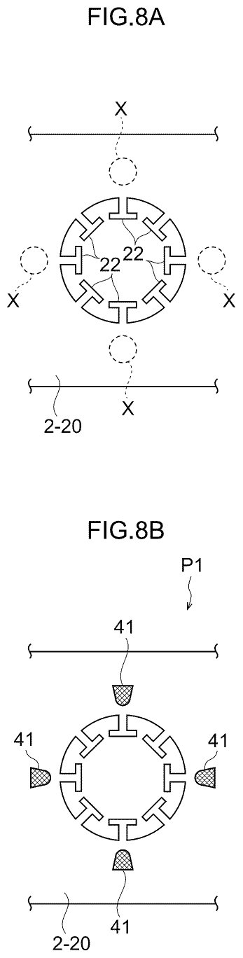

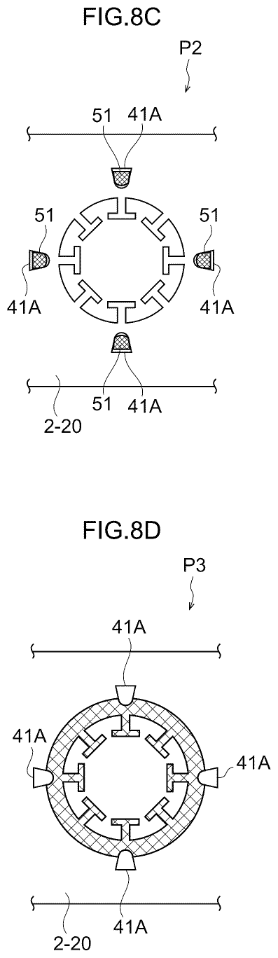

The die unit 32 includes a first die 40 capable of forming the non-latching iron core member recessed portions 23 in a plurality of latching piece forming regions X (see FIG. 7A and FIG. 8A) of the metal sheet 2 where the latching pieces 13A are to be formed, a second die 50 capable of forming the latching iron core member recessed portions 13 in the latching piece forming regions X of the metal sheet 2, and a third die 60 capable of separating the latching iron core members 10 and the non-latching iron core members 20 from the metal sheet 2. As mentioned above, the first to third dies 40, 50, 60 may be disposed in the first to third punching regions P1 to P3, respectively.

Describing the die unit 32 now in greater detail, the die unit 32 mainly includes: a punch plate 34 that configures an upper die, is attached to a punch holder (not shown in the drawings), and has a plurality of punches attached to it; a die plate 35 that configures a lower die and has a plurality of dies attached to it; and a stripper 36 that is elastically attached to the punch holder. It will be noted that the die unit 32 can also include, in addition to the aforementioned configurations, guide pins that guide the up and down movement of the punch plate, positioning pins that perform positioning in the horizontal direction, and a spring that supports the stripper, but since these are all known configurations in the technical field of progressive press dies, illustration and detailed description will be omitted.

The laminated body manufacturing apparatus 1 pertaining to the present embodiment can, by switching between and punching two types of iron core members as mentioned above, efficiently execute laminating work in the subsequent laminating unit 4. Additionally, in order to switch between and punch two types of iron core members, it implements a punching process using the first to third dies 40, 50, 60. Here, it can be expected that when punching two iron core members having different shapes, dedicated dies for forming these two iron core members will be prepared and the two dedicated dies will be controlled on and off to thereby carry out the punching of the two iron core members having different shapes. However, implementing on/off control of the two dies in parallel complicates the control.

In consideration of the above point, the die unit 32 of the laminated body manufacturing apparatus 1 pertaining to the present embodiment modifies the structures and the like of the first to third dies 40, 50, 60 in order to punch the two iron core members having different shapes while reducing the number of dies for which on/off control is necessary. Thus, below, the structures and the like of the first to third dies 40, 50, 60 will be described in detail.

The first die 40 configuring part of the die unit 32 can be configured by first punches 41 that are secured to the punch plate 34 and a first die body (not shown in the drawings) that is provided in a position in the die plate 35 opposing the first punches 41. Furthermore, the first die 40 is disposed in the first punching region P1 positioned upstream in the first conveyance direction A1. The first die 40 can punch the non-latching iron core member recessed portions 23 in the latching piece forming regions X of the metal sheet 2.

In addition, the punching operation by the first die 40 is controlled on and off based on a control signal from a control device 100 described below. Consequently, when the punching operation of the first die 40 is set to off, the punching operation by the first die 40 is not implemented, and the non-latching iron core member recessed portions 23 are punched in the metal sheet 2 only when the punching operation of the first die 40 is on.

The structure for controlling the first die 40 on and off is not particularly limited and can be realized by, for example, disposing on the base portion of the first punches 41 a control cam (not shown in the drawings) for allowing or limiting the relative movement of the first punches 41 in the up and down direction with respect to the punch plate 34. Specifically, when the punching operation of the first die 40 is off, the control cam is operated based on the control signal from the control device 100 to move to a position where it does not support the base portion of the first punches 41. In this state, when the first punches 41 are lowered by the press machine 33 and come into contact with the metal sheet 2, the first punches 41 are pushed by the metal sheet 2 and drawn into the punch plate 34, so that the punching operation is not performed. Alternatively, a configuration may also be employed where the first punches 41 are capable of being held in a position where they do not come into contact with the metal sheet 2 by a control cam different from the one described above.

The second die 50 configuring part of the die unit 32 can be configured by second punches 51 that are secured to the punch plate 34 and a second die body (not shown in the drawings) that is provided in a position in the die plate 35 opposing the second punches 51. Furthermore, the second die 50 is disposed downstream of the first punching region P1 in the first conveyance direction A1. The second die 50 can punch the latching iron core member recessed portions 13 in the latching piece forming regions X of the metal sheet 2. Furthermore, the punching operation by the second die 50 is not controlled on and off as in the case of the first die 40 but is always implemented when the press machine 33 is in operation.

Here, as mentioned above, the latching iron core member recessed portions 13 include parts positioned on the outer sides of the non-latching iron core member recessed portions 23 in plan view when the latching iron core members 10 and the non-latching iron core members 20 are laminated. Consequently, the outer diameters of the second punches 51 that punch the latching iron core member recessed portions 13 are preferably adjusted to be smaller than those of the first punches 41 that punch the non-latching iron core member recessed portions 23. Furthermore, the first punches 41 and the second punches 51 both have their arrangement and the like adjusted so as to punch the latching piece forming regions X of the metal sheet 2. Consequently, the punching operation by the second die 50 with respect to the metal sheet 2 that has been conveyed to the second punching region P2 after the punching operation by the first die 40 has been implemented in the first punching region P1 is such that the second die 50 simply passes through (i.e., empty-punches) the regions already punched by the first die 40.

When the second die 50 empty-punches the metal sheet 2 on which the punching operation by the first die 40 has been performed as described above, the metal sheet 2 and the second punches 51 do not come into contact with each other during the punching operation by the second die 50. For that reason, fine debris that can be occur during the punching operation is not generated. Consequently, the metal sheet 2 and the die can be inhibited from being scratched as a result of coming into contact with such fine debris. Furthermore, deformation of the metal sheet 2 caused by contact between the metal sheet 2 and the second punches 51 can be inhibited. Moreover, since punching by the second die 51 is not performed, the latching iron core member recessed portions 13 are not formed in the non-latching iron core member 20.

The third die 60 configuring part of the die unit 32 can be configured by third punches 61 that are secured to the punch plate 34 and a third die body 62 that is provided in a position in the die plate 35 opposing the third punches 61. Furthermore, the third die 60 is disposed downstream of the second punching region P2 in the first conveyance direction A1. The third die 60 is a die for implementing what is called outer periphery punching and can punch the outer peripheral parts of the latching iron core members 10 and the non-latching iron core members 20. Furthermore, the punching operation by the third die 60 is also, like that of the second die 50, always implemented when the press machine 33 is in operation.

As shown in FIG. 3, the laminating unit 4 of the laminated body manufacturing apparatus 1 includes at least a receiving member 70 that receives the latching iron core members 10 and the non-latching iron core members 20 that have been separated from the metal sheet 2 and a squeeze 80 that serves as an example of a support mechanism capable of supporting the latching pieces 13A of the latching iron core members 10 that have been separated from the metal sheet. It will be noted that in the laminating unit 4 in FIG. 3, the latching iron core members 10 and the non-latching iron core members 20 after being punched are shown in a sectional view taken at a position corresponding to line C-C shown in FIG. 1. Furthermore, in the laminating unit 4 in FIG. 3, just the dimension of the latching pieces 13A is shown larger than the actual dimension in order to facilitate understanding of the state of the latching pieces 13A, and illustration of the through holes and the teeth 12, 22 formed in the centers of the iron core members 10, 20 is omitted. Moreover, in the laminating unit 4 in FIG. 3, slight gaps are shown between the iron core members so that the boundaries between the iron core members, which are conveyed in a laminated state, can be seen.

The receiving member 70 can, for example, be configured by a jig that is positioned under the third die body 62 and is capable of receiving the latching iron core members 10 and the non-latching iron core members 20 conveyed out from the progressive die mechanism 30. The receiving member 70 can include a base 71 on which the latching iron core members 10 and the non-latching iron core members 20 conveyed out from the progressive die mechanism 30 are capable of being placed, a plurality of support poles 72 that extend upward from the upper surface of the base 71 and laterally support the latching iron core members 10 and the non-latching iron core members 20, and a conveyance arm 73 that moves the base 71 in optional directions.

Of the above configurations, the conveyance arm 73 may be capable of supporting the underside of the base 71 and moving the base 71 in predetermined directions such as, for example, at least one of the front and rear direction, the left and right direction, and the up and down direction. In addition, the conveyance arm 73 may function as a rotating mechanism that rotates the base 71. That is, it may be capable of rotationally building up the laminated body placed on the base 71 by rotating the supported base 71 about an axis of rotation extending in the up and down direction.

The structure of the receiving member 70 described above is one example, and the receiving member 70 is not limited to the above structure as long as it is capable of receiving each of the iron core members 10, 20 supplied from the progressive die mechanism 30. Specifically, the receiving member 70 can also be configured by other conveying means such as a conveyor or a slope.

The squeeze 80 may be disposed between the third die body 62 and the receiving member 70 and convey, along a second conveyance direction A2 intersecting the first conveyance direction Al while laterally supporting, the latching iron core members 10 and the non-latching iron core members 20 that have been supplied from the progressive die mechanism 30 and separated from the metal sheet 2. In the present embodiment, the second conveyance direction A2 corresponds to the up and down direction.

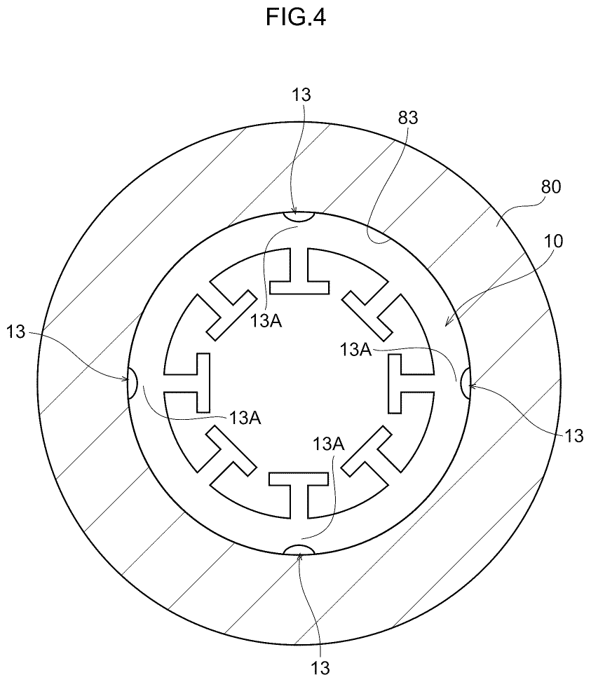

FIG. 4 is a schematic sectional view taken along line D-D of FIG. 3. The squeeze 80 is disposed downstream of the third die body 62 in the second conveyance direction A2 and is capable of conveying, along the conveyance direction while laterally supporting, the latching iron core members 10 and the non-latching iron core members 20 conveyed out from the progressive die mechanism 30. As shown in FIG. 3 and FIG. 4, the squeeze 80 can be configured by a substantially cylindrical member having one end connected to the lower end of the third die body 62. Furthermore, the squeeze 80 can convey, in a mutually laminated state, the latching iron core members 10 and the non-latching iron core members 20 that have been punched and pushed out downward of the third die body 62.

The latching iron core members 10 and the non-latching iron core members 20 conveyed out from the progressive die mechanism 30 can be sequentially conveyed into and supported by the upper end of the squeeze 40. Consequently, each time a new latching iron core member 10 or non-latching iron core member 20 is conveyed into the squeeze 80, the latching iron core members 10 and the non-latching iron core members 20 that were already being held inside the squeeze 80 are pushed by that conveyed latching iron core member 10 or non-latching iron core member 20 and become conveyed downward through the squeeze 80 by an amount corresponding to its thickness.

In addition, the squeeze 80 can include a squeeze upstream portion 81 that is positioned upstream in the second conveyance direction A2 and laterally supports both the latching iron core members 10 and the non-latching iron core members 20 passing through the squeeze 80 and a squeeze downstream portion 82 that is positioned downstream in the conveyance direction of the iron core members and laterally supports the latching pieces 13A of the latching iron core members 10 passing through the squeeze 80.

As shown in FIG. 4, an inner peripheral surface 83 of the squeeze upstream portion 81 may be adjusted to a size matching the shapes of the latching iron core members 10 and the non-latching iron core members 20 being conveyed through the squeeze 80. Because of this, the sides (i.e., outer peripheries) of the latching iron core members 10 and the non-latching iron core members 20 passing through the squeeze 80 can abut against and be supported by the inner peripheral surface 83 of the squeeze upstream portion 81.

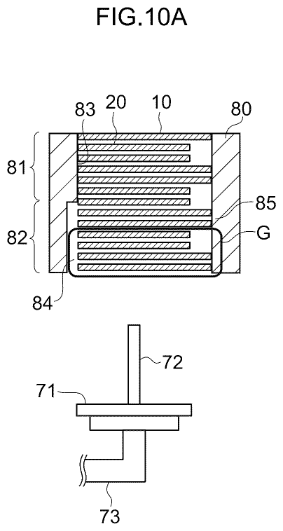

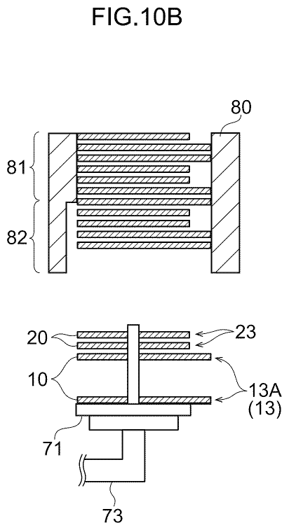

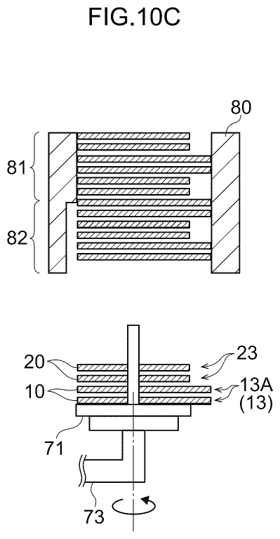

An example is described where, as shown in FIG. 4, the inner peripheral surface 83 of the squeeze upstream portion 81 pertaining to the present embodiment has a shape matching the outer peripheral shapes of the latching iron core members 10 and the non-latching iron core members 20 excluding the latching iron core member recessed portions 13 and the non-latching iron core member recessed portions 23. However, the specific structure of the inner peripheral surface 83 is not limited to this as long as it is a structure that can laterally support the latching iron core members 10 and the non-latching iron core members 20. For example, the inner peripheral surface 83 may have a shape that abuts against only part of the outer peripheral surface of each of the iron core members. Furthermore, although in FIG. 3 and in FIG. 10 etc. described below only a comparatively small number of iron core members are shown being conveyed through the squeeze 80 in order to facilitate understanding, the number of iron core members conveyable through the squeeze 80 may be from several dozens to several hundreds. Additionally, the total number of iron core members configuring a laminated body may also be from several dozens to several hundreds.

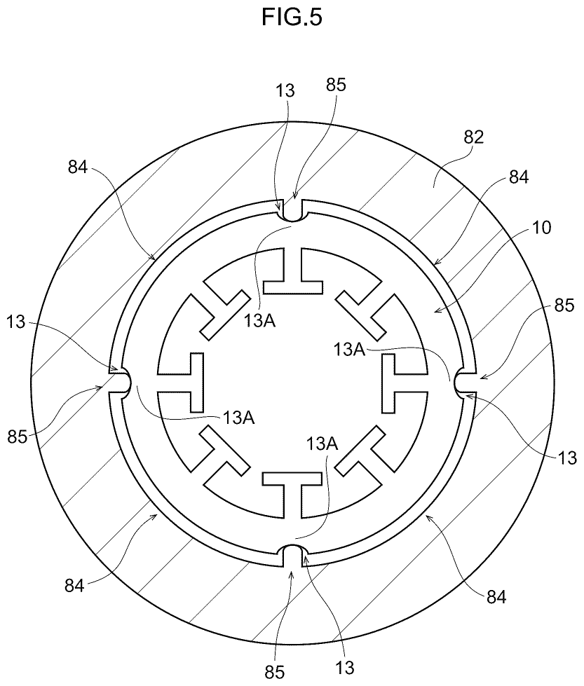

FIG. 5 is a schematic sectional view taken along line E-E of FIG. 3. As shown in FIG. 5, the squeeze downstream portion 82 may have, in positions on its inner peripheral surface opposing the latching pieces 13A of the latching iron core members 10, latching projections 85 that extend in the central direction of the squeeze 80. The latching projections 85 can laterally abut against the latching pieces 13A and support the latching iron core members 10.

Here, in the squeeze downstream portion 82, the parts of the inner peripheral surface other than the parts where the latching projections 85 are formed do not support either the latching iron core members 10 or the non-latching iron core members 20. In other words, gaps 84 are formed between the parts of the inner peripheral surface of the squeeze downstream portion 82 excluding the parts where the latching projections 85 are formed and the outer peripheral surfaces of the iron core members. It will be noted that the shape of the inner peripheral surface of the squeeze downstream portion 82 may be changed as appropriate to match the shapes of the latching iron core members 10 and the non-latching iron core members 20 that are conveyed.

When the squeeze 80 is employed, only the latching iron core members 10 are conveyed in a supported state in the squeeze downstream portion 82, and the non-latching iron core members 20 move through the squeeze downstream portion 82 without being laterally supported by the squeeze 80 in a state in which they are placed on the upper surface of the latching iron core member 10 positioned downstream. Additionally, the non-latching iron core members 20 inside the squeeze downstream portion 82 are conveyed out from the squeeze 80 at the same time that the latching iron core members 10 positioned under them are conveyed out from the lower end portion of the squeeze 80.

In order to control each of the aforementioned constituent elements, the manufacturing apparatus 1 pertaining to the present embodiment can further include a control device 100. The control device 100 may be communicably connected to each of the constituent elements via wired or wireless communication as indicated by the dotted lines in FIG. 3 for example. For the control device 100, a computer including a sequencer (a Programmable Logic Controller, or PLC) can be employed. The control device 100 can at least execute on/off control of the punching operation by the first die 40.

As described above, by giving the laminated body manufacturing apparatus 1 a configuration where the outbound conveyance of the non-latching iron core members 20 and the outbound conveyance of the latching iron core members 10 are performed at the same time, the interval of time from when the non-latching iron core members 20 are conveyed out to when the latching iron core members 10 are next conveyed out from the lower end portion of the squeeze 80 becomes longer. Consequently, by performing replacement of the receiving member 70 or rotational build-up at this timing, laminating of the iron core members can be continuously and accurately executed without temporarily stopping the apparatus for replacement of the receiving member 70 or rotational build-up and without using special devices or the like for controlling the timing of the supply of the iron core members to the receiving member 70.

In the present embodiment, the squeeze 80 was described as an example of the support mechanism capable of supporting the latching pieces 13A, and an example was described where the squeeze 80 selectively latches the latching pieces 13A of the latching iron core members 10 to control the timing of the supply to the receiving member 70. However, a structure other than the squeeze 80 can also be employed as long as it is a support structure capable of the same control.

As described above, according to the laminated body manufacturing apparatus 1 pertaining to the present embodiment, it becomes possible to selectively punch the latching iron core members 10 that have latching pieces and the non-latching iron core members 20 that do not have latching pieces as the iron core members and control the supply timing of the iron core members by supporting the latching pieces at an optional timing. Consequently, laminating of the iron core members can be performed without employing special devices.

Furthermore, in the laminated body manufacturing apparatus 1 pertaining to the present embodiment, the latching iron core member recessed portions 13 and the non-latching iron core member recessed portions 23 are provided in common positions in the latching iron core members 10 and the non-latching iron core members 20, respectively, and the latching pieces 13A are formed by slightly changing the depth of these recessed portions. For that reason, effects on the magnetic properties of the motor core caused by the presence or absence of the latching pieces 13A can be virtually eliminated.

It will be noted that although an example was described where, in the laminated body manufacturing apparatus 1 pertaining to the present embodiment, the second die 50 and the third die 60 were disposed in the second and third punching regions P2 and P3, respectively, the second die 50 and the third die 60 can also be combined into a one die. Specifically, instead of the second die 50 and the third die 60, a fourth die comprising a combination of the second die 50 and the third die 60 may be disposed in a fourth punching region provided downstream of the first punching region P1 in the first conveyance direction A1. By configuring the laminated body manufacturing apparatus 1 in this way, the number of dies and punching regions can be reduced, thus improving the working efficiency of the punching.

Furthermore, although in the present embodiment shapes including the latching iron core member recessed portions 13 and the non-latching iron core member recessed portions 23 were described as an example of the latching iron core member contour shapes and the non-latching iron core member contour shapes formed in the latching piece forming regions X, these contour shapes are not limited to recessed portions. Specifically, for example, as the latching iron core member contour shapes, shapes capable of forming, in the latching piece forming regions X of the latching iron core members 10, raised portions that project outward and can function as the latching pieces may be employed, and as the non-latching iron core member contour shapes, shapes capable of forming, in the latching piece forming regions X of the non-latching iron core members 20, curved surfaces that are continuous with the other outer peripheral surfaces of the non-latching iron core members 20 may be employed. In this case also, the latching iron core member contour shapes include parts (specifically, the raised portions) positioned on the outer sides of the non-latching iron core member contour shapes in plan view when the latching iron core members and the non-latching iron core members are laminated.

### Laminated Body Manufacturing Method

Next, a laminated body manufacturing method pertaining to the present embodiment will be described. In the following description, a case where the laminated body manufacturing apparatus 1 is used to manufacture a laminated body will be described as an example, but the laminated body manufacturing method of this disclosure can also be implemented by apparatus other than the manufacturing apparatus 1. The laminated body manufacturing method pertaining to the present embodiment, which is realized by the laminated body manufacturing apparatus 1, can be provided in the form of a program for causing a processor of the control device 100 that controls each of the constituent elements of the laminated body manufacturing apparatus 1 to execute predetermined operations or in the form of a non-transitory computer-readable recording medium in which the program is stored. It will be noted that the following description of effects and the like doubles as a description of the effects of the manufacturing apparatus 1 pertaining to the present embodiment.

First, a process for punching the latching iron core members 10 and the non-latching iron core members 20 in the laminated body manufacturing method pertaining to the present embodiment will be described. The punching in the laminated body manufacturing method pertaining to the present embodiment includes at least, in order to selectively punch the latching iron core members 10 and the non-latching iron core members 20 from the metal sheet 2 conveyed along the first conveyance direction A1: a step of using the first die 40, which forms the non-latching iron core member recessed portions 23 of the non-latching iron core members 20, to punch the plurality of latching piece forming regions X of the metal sheet 2 when forming the non-latching iron core members 20; a step of using the second die 50, which is for forming the latching iron core member recessed portions 13 of the latching iron core members 10, to punch the latching piece forming regions X of the metal sheet 2 when forming the latching iron core members 10 and the non-latching iron core members 20; and a step of using the third die 60 to punch the metal sheet 2 in order to separate the latching iron core members 10 and the non-latching iron core members 20 from the metal sheet 2.

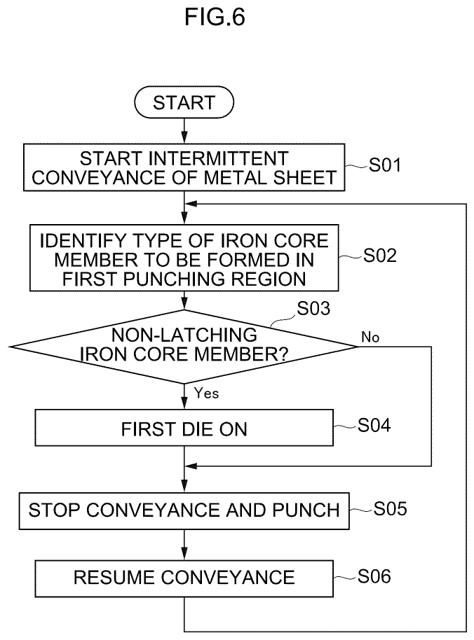

FIG. 6 is a flowchart showing an example of the laminated body manufacturing method pertaining to the first embodiment of the disclosure. Describing now the control process of the manufacturing apparatus 1 when executing the laminated body manufacturing method pertaining to the present embodiment, as shown in FIG. 6, first, intermittent conveyance of the strip-shaped metal sheet 2 is started by the conveyance mechanism 31 (step S01). The intermittent conveyance may use as the conveyance pitch the distance between the punching regions P1 to P3 disposed along the first conveyance direction A1.

Next, the type of iron core member to be formed in the first punching region P1 is identified with reference to the work recipe or the like input by the user or the like of the manufacturing apparatus 1 (step S02). When, as a result of this identification, the iron core member to be formed in the first punching region P1 is the non-latching iron core member 20 (Yes in step S03), the first die 40 is switched on (step S04). On the other hand, when the iron core member to be formed in the first punching region P1 is not the non-latching iron core member 20, i.e., is the latching iron core member 10 (No in step S03), the first die 40 remains off and the process moves to the next step.

When the on/off control of the first die 40 is completed, the conveyance by the conveyance mechanism 31 is stopped and the press machine 33 is operated to execute a punching operation (step S05). At this time, when the metal sheet 2 is also in the second and third punching regions P2 and P3, punching operations are also executed by the second and third dies 50 and 60 in addition to the first die 40. When the punching operation is completed, the conveyance of the metal sheet 2 is resumed (step S06), the process returns to step S02, and the above series of processes are executed.

Next, changes in the punched shape of the metal sheet 2 when punching the latching iron core member 10 or the non-latching iron core member 20 in a specific region of the metal sheet 2 will be described using FIG. 7 and FIG. 8. It will be noted that in the following description, the metal sheet 2 from which the latching iron core member 10 is punched will be referred to as “the metal sheet 2-10” and the metal sheet 2 from which the non-latching iron core member 20 is punched will be referred to as “the metal sheet 2-20” so that it can be understood which core member is formed in the specific area of the metal sheet 2 shown in the drawings.

FIG. 7 are schematic plan views of the metal sheet in each operating state shown in FIG. 6 and are explanatory drawings showing the states of the metal sheet when punching the latching iron core member. First, a case where the latching iron core member 10 is punched in a specific position of the metal sheet 2 will be described with reference to FIG. 7. The teeth 12 of the latching iron core member 10 are preferably formed in advance in the metal sheet 2-10 as shown in FIG. 7A before conveyance into the progressive die mechanism 30. The formation and the like of the teeth 12 can be implemented using something similar to the progressive die mechanism 30.

Conveyance of the metal sheet 2-10 is performed by the conveyance mechanism 31, and when the metal sheet 2-10 reaches the first punching region P1, the press machine 33 is operated to lower the die unit 32. Here, since the latching iron core member 10 is to be formed in the metal sheet 2-10 shown in FIG. 8, the punching operation by the first die 40 is switched off (see step S03 in FIG. 6). Consequently, in the metal sheet 2-10 that has reached the first punching region P1, as shown in FIG. 7B, first punch holes 41A (see FIG. 8B) formed by the first die 40 are not formed.

When the operation of lowering the die unit 32 in the first punching region P1 is completed, the metal sheet 2-10 is conveyed by the conveyance mechanism 31 to the second punching region P2. When the metal sheet 2-10 reaches the second punching region P2, the press machine 33 is operated again to lower the die unit 32. Since the second die 50 is always on, second punch holes 51A are formed by this lowering by the second die 50 in four latching piece forming regions X of the metal sheet 2-10 as shown in FIG. 7C.

When the operation of lowering the die unit 32 in the second punching region P2 is completed, the metal sheet 2-10 is conveyed by the conveyance mechanism 31 to the third punching region P3. When the metal sheet 2-10 reaches the third punching region P3, the press machine 33 is operated again to lower the die unit 32. The third die 60 performs outer periphery punching, and since it is always on like the second die 50, the latching iron core member 10 is punched from the metal sheet 2-10 by this lowering as shown in FIG. 7D and is conveyed out downward of the third die body 62.

FIG. 8 are schematic plan views of the metal sheet in each operating state shown in FIG. 6 and are explanatory drawings showing the state of the metal sheet when punching the non-latching iron core member. Next, a case where the non-latching iron core member 20 is punched in a specific position of the metal sheet 2 will be described with reference to FIG. 8. As with the metal sheet 2-10, the teeth 22 of the non-latching iron core member 20 are preferably formed in advance in the metal sheet 2-20 as shown in FIG. 8A before conveyance into the progressive die mechanism 30.

Conveyance of the metal sheet 2-20 is performed by the conveyance mechanism 31, and when the metal sheet 2-20 reaches the first punching region P1, the press machine 33 is operated to lower the die unit 32. Here, since the non-latching iron core member 20 is to be formed in the metal sheet 2-20 shown in FIG. 8, the punching operation by the first die 40 is switched on (see step S03 in FIG. 6). Consequently, in the four latching piece forming regions X of the metal sheet 2-20, as shown in FIG. 8B, first punch holes 41A are formed by the first die 40.

When the operation of lowering the die unit 32 in the first punching region P1 is completed, the metal sheet 2-20 is conveyed by the conveyance mechanism 31 to the second punching region P2. When the metal sheet 2-20 reaches the second punching region P2, the press machine 33 is operated again to lower the die unit 32. Since the second die 50 is always on, a punching operation by the second die 50 is performed by this lowering in the four latching piece forming regions X of the metal sheet 2-10 as shown in FIG. 8C. However, in the metal sheet 2-20, the first punch holes 41A have already been formed in the first punching region P1. Furthermore, as mentioned above, the latching iron core member recessed portions 13 include parts that are positioned on the outer sides (in the radial direction) of the non-latching iron core member recessed portions 23 in plan view when the latching iron core members 10 and the non-latching iron core members 20 are laminated. Consequently, at least inner parts of the second punches 51 pass through the first punch holes 41A without coming into contact with the metal sheet 2.

Here, in order to ensure that fine debris is not generated by, for example, the second punches 51 coming into contact with parts of the radial direction outer sides of the first punch holes 41A during the punching operation by the second die 50, the size and shape of the second punches 51 are preferably adjusted so that the second punches 51 are completely contained within the first punch holes 41A as shown in FIG. 8C.

When the operation of lowering the die unit 32 in the second punching region P2 is completed, the metal sheet 2-20 is conveyed by the conveyance mechanism 31 to the third punching region P3. When the metal sheet 2-20 reaches the third punching region P3, the press machine 33 is operated again to lower the die unit 32. The third die 60 performs outer periphery punching, and since it is always on like the second die 50, the non-latching iron core member 20 is punched by this lowering from the metal sheet 2-20 as shown in FIG. 8D and is conveyed out downward of the third die body 62.

As described above, according to the punching process of the laminated body manufacturing method pertaining to the present embodiment, two core members having different outer shapes, namely the latching iron core member 10 and the non-latching iron core member 20, can be selectively punched by simply controlling the first die 40 on and off.

Next, the process of laminating the punched latching iron core members 10 and non-latching iron core members 20 to manufacture a stack in the laminated body manufacturing method pertaining to the present embodiment will be described. The laminating process in the laminated body manufacturing method pertaining to the present embodiment includes at least a step of controlling the timing of the supply of the latching iron core members 10 and the non-latching iron core members 20 to the receiving member 70 by supporting the latching pieces 13A of the latching iron core members 10 that have been punched from the metal sheet 2. In the present embodiment, this step is mainly realized by the squeeze 80.

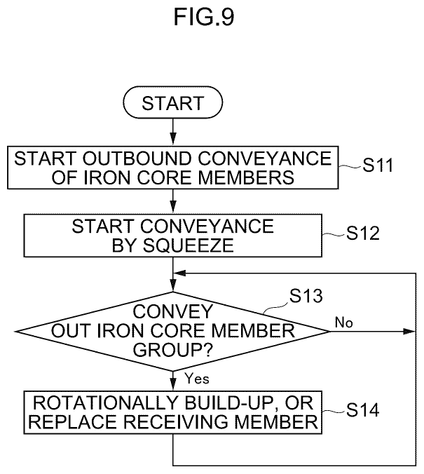

FIG. 9 is a flowchart showing an example of a process implemented after each process shown in FIG. 6. Furthermore, FIG. 10 are operational explanatory drawings showing main parts of the manufacturing apparatus shown in FIG. 3 when the laminated body manufacturing method shown in FIG. 9 is executed. Below, the process of manufacturing a laminated body in the laminated body manufacturing method pertaining to the present embodiment will be described with reference to FIG. 9 and FIG. 10.

As shown in FIG. 9, the laminating process in the laminated body manufacturing method pertaining to the present embodiment begins with the start of the outbound conveyance of the latching iron core members 10 and the non-latching iron core members 20 from the progressive die mechanism 30 as the punching process progresses (step S11).

Here, an example will be described where, in the laminated body manufacturing method pertaining to the present embodiment, rotational build-up or replacement of the receiving member 70 is performed each time an iron core member group G comprising four iron core members is laminated on the receiving member 70. In association with this, the iron core members conveyed out from the progressive die mechanism 30 are preferably such that, among the plurality (four in FIG. 8) of iron core members configuring the one iron core member group G, the latching iron core members 10 make up one or a plurality of the iron core members positioned downstream and the non-latching iron core members 20 make up one or a plurality of the iron core members positioned upstream. In other words, of the plurality of iron core members configuring the one iron core member group G, at least the first core member to be punched in the progressive die mechanism 30 is a latching iron core member 10 while the rest are non-latching iron core members 20. This is because it is necessary to support the iron core member positioned most downstream in the iron core member group G in order to temporarily stop the supply of the iron core members to the receiving member 70 when performing rotational build-up or replacement of the receiving member 70. It will be noted that in the present embodiment an example is described where two each of the latching iron core members 10 and the non-latching iron core members 20 are alternately punched in the progressive die mechanism 30, so that one iron core member group G has two latching iron core members 10 and two non-latching iron core members 20 that are sequentially laminated from downstream.

The latching iron core members 10 and the non-latching iron core members 20 punched by the third die 60 move downward of the third die body 62 as a result of being pushed by the third punches 61 and are pushed into the squeeze 80 from the upper end portion of the squeeze 80 connected to the third die body 62. At least parts of the outer peripheral surfaces of the latching iron core members 10 and the non-latching iron core members 20 pushed into the squeeze 80 are laterally supported by the inner peripheral surface 83 of the squeeze upstream portion 81, and the latching iron core members 10 and the non-latching iron core members 20 are conveyed in a mutually laminated state through the squeeze 80 (step S12).

When the conveyance of the iron core members by the squeeze 80 progresses, the latching iron core members 10 and the non-latching iron core members 20 that had been conveyed through the squeeze upstream portion 81 reach the squeeze downstream portion 82. The lateral support of the latching iron core members 10 among the iron core members that have reached the squeeze downstream portion 82 is maintained as a result of the latching pieces 13A coming into contact with the latching projections 85 provided on the inner peripheral surface of the squeeze downstream portion 82. On the other hand, since the non-latching iron core members 20 do not have the latching pieces 13A, the lateral support of the non-latching iron core members 20 is canceled, and the non-latching iron core members 20 are placed on and supported by the upper surface of the latching iron core member 10 positioned downstream of them (see FIG. 10A).

When the conveyance of the iron core members by the squeeze 80 progresses further, the latching iron core member 10 positioned most downstream among the iron core members configuring the one iron core member group G is conveyed out from the lower end portion of the squeeze 80. Next, the latching iron core member 10 (hereinafter, to facilitate understanding of the description, this latching iron core member 10 will for the present be called “the second latching iron core member 10”) that had been conveyed through the squeeze downstream portion 82 in a laminated state with its lower surface abutting against the upper surface of the latching iron core member 10 positioned most downstream is similarly conveyed out from the lower end portion of the squeeze 80.

Here, the second latching iron core member 10 is supported with the two non-latching iron core members 20 included in the same iron core member group G placed on its upper surface. The non-latching iron core members 20 are not supported by the squeeze downstream portion 82. For that reason, when the second latching iron core member 10 is conveyed out from the lower end portion of the squeeze 80, the two non-latching iron core members 20 are also conveyed out from the lower end portion of the squeeze 80 at the same time as shown in FIG. 10B. Additionally, at this time, the latching iron core members 10 that had been laminated upstream of the two non-latching iron core members 20 are conveyed through a position away from the lower end portion of the squeeze 80.

When the second latching iron core member 10 and the two non-latching iron core members 20 supported on its upper surface are placed on the base 71 of the receiving member 70 (Yes in step S13), rotational build-up by the receiving member 70 or replacement of the receiving member 70 is performed as shown in FIG. 10C (step S14). Of these, the rotational build-up can be implemented by operating the conveyance arm 73 to rotate the base 71 on which the one iron core member group G has been placed. Here, at the timing when this rotational build-up is executed, the latching iron core member 10 to be conveyed next to the receiving member 70 is conveyed through a position away from the lower end portion of the squeeze 80 as described above. For that reason, a relatively long amount of time is ensured until the latching iron core member 10 is conveyed out from the lower end portion of the squeeze 80. Consequently, a new iron core member is not conveyed out from the squeeze 80 while the rotational build-up is being executed. Furthermore, in step S14, replacement of the receiving member 70 may be executed when the desired number of iron core members 10 are laminated on the base 71. When the rotational build-up or the replacement of the receiving member 70 is completed in step S14, the process returns to step S13 and stands by until the next iron core member group G is conveyed out.

As described above, according to the laminating process of the laminated body manufacturing method pertaining to the present embodiment, the supply timing of the iron core members conveyed out from the lower end portion of the squeeze 80 can be adjusted by simply modifying the shape of part of the inner peripheral surface of the squeeze 80. Consequently, the manufacture of laminated bodies can be continuously performed with a simple structure. Furthermore, because the squeeze downstream portion 82 has a structure that supports only the latching iron core members 10, each time an iron core member group G is conveyed out, a long amount of time is ensured until the next outbound conveyance, so rotational build-up or replacement of the receiving member 70 can be executed without stopping the apparatus. Consequently, laminated body production efficiency improves.

As an option, although in the above embodiment an example was described where one iron core member group G was configured such that the downstream two iron core members are latching iron core members 10 and the two upstream iron core members are non-latching iron core members 20, it may also be configured such that just one downstream iron core member is a latching iron core member 10 and the remaining three iron core members are non-latching iron core members 20. By increasing the number of non-latching iron core members 20 configuring the iron core member group G in this way, a longer amount of time until the iron core members included in the next iron core member group G are conveyed out from the squeeze 80 can be ensured.

The present disclosure is not limited to the embodiment described above and can be changed and implemented in a variety of ways without departing from the spirit of the disclosure. Additionally, all these are included in the technical thought of the disclosure.

All documents including publications, patent applications, and patents mentioned in this specification are incorporated herein by reference to the same extent as if each individual document were specifically and individually indicated to be incorporated by reference and were set forth in its entirety herein.

The use of nouns and similar referents used in the context of describing this disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including but not limited to”) unless otherwise noted. Recitation of numerical ranges herein is intended merely to serve as a shorthand method for referring individually to each separate value falling within the range, unless otherwise indicated herein, and each separate value is incorporated into the specification as if it were individually listed herein. All methods described herein can be performed in any suitable order unless otherwise indicated herein or otherwise clearly contradicted by context. The use of any and all examples or exemplary language (e.g., “such as”) herein is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of the disclosure are described herein, including the best modes known to the inventor for carrying out the disclosure. Variations of these preferred embodiments may become apparent to those of ordinary skill in the art upon reading the foregoing description. The inventor expects skilled artisans to apply such variations as appropriate, and the inventor intends for the disclosure to be practiced otherwise than as specifically described herein. Accordingly, the disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A method of manufacturing a laminated body in which a plurality of iron core members including latching iron core members that have latching pieces at a plurality of places on their outer peripheral surfaces and non-latching iron core members that do not have the latching pieces are selectively punched from a metal sheet conveyed along a first conveyance direction and in which the plurality of iron core members that have been punched are laminated, the laminated body manufacturing method comprising:
using a first die, which is capable of forming non-latching iron core member contour shapes that are formed at outer peripheral surfaces of the non-latching iron core members, to punch a plurality of latching piece forming regions of the metal sheet where the latching pieces are to be formed when forming the non-latching iron core members;
using a second die, which is capable of forming latching iron core member contour shapes including the latching pieces that are formed at the outer peripheral surfaces of the latching iron core members, to punch the latching piece forming regions of the metal sheet when forming the latching iron core members and the non-latching iron core members, the latching iron core member contour shapes including parts that are positioned on outer sides of the non-latching iron core member contour shapes in plan view when the latching iron core members and the non-latching iron core members are laminated;
using a third die to punch the metal sheet in order to separate the latching iron core members and the non-latching iron core members from the metal sheet; and
controlling a timing of supply of the latching iron core members and the non-latching iron core members to a receiving member by supporting the latching pieces of the latching iron core members that have been separated from the metal sheet.

2. The laminated body manufacturing method of claim 1, wherein:
along the first conveyance direction, first to third punching regions are sequentially provided from upstream in the first conveyance direction, and
using the first die to punch the metal sheet is implemented in the first punching region, using the second die to punch the metal sheet is implemented in the second punching region, and using the third die to punch the metal sheet is implemented in the third punching region.

3. The laminated body manufacturing method of claim 1, wherein:
along the first conveyance direction, first and fourth punching regions are sequentially provided from upstream in the first conveyance direction, and
using the first die to punch the metal sheet is implemented in the first punching region, and using the second die to punch the metal sheet and using the third die to punch the metal sheet are implemented in the fourth punching region by a fourth die configured by the second die and the third die.

4. The laminated body manufacturing method of claim 1, wherein:
controlling the timing of the supply of the latching iron core members and the non-latching iron core members to the receiving member includes supplying the latching iron core members and the non-latching iron core members that have been separated from the metal sheet to a squeeze and supplying the iron core members to the receiving member from an end portion of the squeeze located downstream in a second conveyance direction intersecting the first conveyance direction, and
the squeeze includes a squeeze upstream portion that is positioned on a second conveyance direction upstream side of the squeeze and laterally supports a plurality of the latching iron core members and the non-latching iron core members passing through the squeeze and a squeeze downstream portion that is positioned on a second conveyance direction downstream side of the squeeze and laterally supports the latching pieces of the latching iron core members passing through the squeeze.

5. A laminated body manufacturing apparatus comprising:
a conveyance mechanism that conveys, along a first conveyance direction, a metal sheet from which a plurality of iron core members including latching iron core members that have latching pieces at a plurality of places on their outer peripheral surfaces and non-latching iron core members that do not have the latching pieces are capable of being selectively punched;
a first die capable of forming, in a plurality of latching piece forming regions of the metal sheet where the latching pieces are to be formed, non-latching iron core member contour shapes that are formed at the outer peripheral surfaces of the non-latching iron core members;
a second die capable of forming, in the latching piece forming regions of the metal sheet, latching iron core member contour shapes including the latching pieces that are formed at the outer peripheral surfaces of the latching iron core members, the latching iron core member contour shapes including parts that are positioned on outer sides of the non-latching iron core member contour shapes in plan view when the latching iron core members and the non-latching iron core members are laminated;
a third die capable of separating the latching iron core members and the non-latching iron core members from the metal sheet;
a press machine capable of operating the first die, the second die, and the third die;
a receiving member that receives the latching iron core members and the non-latching iron core members that have been separated from the metal sheet;
a support mechanism capable of supporting the latching pieces of the latching iron core members that have been separated from the metal sheet; and
a control device that controls implementation of a punching operation by the first die.

6. The laminated body manufacturing apparatus of claim 5, wherein:
the support mechanism includes a squeeze capable of conveying, in a second conveyance direction intersecting the first conveyance direction, the latching iron core members and the non-latching iron core members that have been separated from the metal sheet, and
the squeeze includes a squeeze upstream portion that is positioned on a second conveyance direction upstream side of the squeeze and laterally supports a plurality of the latching iron core members and the non-latching iron core members passing through the squeeze and a squeeze downstream portion that is positioned on a second conveyance direction downstream side of the squeeze and laterally supports the latching pieces of the latching iron core members passing through the squeeze.
